(19) United States
(12) Patent Application Publication
(10) Pub. No.: US 2024/0336497 A1
(43) Pub. Date: Oct. 10, 2024

(54) METHOD FOR OPERATING PURE-WATER PRODUCTION SYSTEM

(71) Applicant: KURITA WATER INDUSTRIES LTD., Tokyo (JP)

(72) Inventors: Rena TABEI, Tokyo (JP); Yasuharu MINATO, Tokyo (JP)

(73) Assignee: KURITA WATER INDUSTRIES LTD., Tokyo (JP)

(21) Appl. No.: 18/580,588

(22) PCT Filed: Mar. 17, 2022
(86) PCT No.: PCT/JP2022/012182

§ 371 Date: Jan. 18, 2024

(30) Foreign Application Priority Data
Jul. 19, 2021 (JP) 2021-119153

(51) Int. Cl. C02F 1/32; C02F 1/26; C02F 1/469; C02F 1/72

(52) U.S. Cl. CPC C02F 1/32; C02F 1/265; C02F 1/4695; C02F 1/72

(57) ABSTRACT

The present invention provides a method for operating a pure-water production system, which includes an ultraviolet oxidation device and an electrical de-ionization device and channels water to these devices in this order from an upstream side. The method includes: setting hydrogen peroxide concentrations of concentrated water in a concentration chamber and electrode water in an electrode chamber of the electrical de-ionization device less than a hydrogen peroxide concentration of treated water that permeates through a desalination chamber of the electrical de-ionization device.

### TECHNICAL FIELD

The present invention relates to a method for operating a pure-water production system, and particularly relates to a method for operating a pure-water production system that constitutes an ultrapure-water production apparatus which produces ultrapure water to be used in the fields of electronic industry such as semiconductors and liquid crystals.

### RELATED ART

Conventionally, ultrapure water used in the fields of electronic industry such as semiconductors is produced by treating raw water with an ultrapure-water production apparatus that includes a pretreatment system, a primary pure-water apparatus, and a sub-system which treats primary pure water.

For example, as shown in FIG. 1, an ultrapure-water production apparatus 1 includes devices in three stages: a pretreatment apparatus 2, a primary pure-water production apparatus (pure-water production system) 3, and a sub-system 4. In the pretreatment apparatus 2 of such an ultrapure-water production apparatus 1, raw water W is subjected to pretreatments such as filtration, flocculation sedimentation, and microfiltration membrane to remove mainly suspended substances.

The primary pure-water production apparatus 3 includes a reverse osmosis membrane device 5 for treating pretreated water W1, a de-aeration membrane device 6, an ultraviolet oxidation device 7, an electrical de-ionization device 9, and a water-supply pump 8 for supplying supply water to the electrical de-ionization device 9. This primary pure-water purification apparatus 3 removes most of the electrolytes, particulates, viable bacteria, etc. from the pretreated water W1, and also decomposes organic matter.

The sub-system 4 includes a sub-tank 10, a supply pump 11, an ultraviolet oxidation device 12, a non-regenerative mixed bed ion exchange device 13, and an ultrafiltration membrane (UF membrane) 14, and is configured for water to flow back from the ultrafiltration membrane (UF membrane) 14 to the sub-tank 10 via a use point 15. In this sub-system 4, a minute amount of organic matter (TOC (total organic carbon) components) contained in the primary pure water W2 produced by the primary pure-water production apparatus 3 is oxidized and decomposed to remove carbonate ions, organic acids, anionic substances, as well as metal ions and cationic substances, and finally ultrapure water W3 is obtained by removing particulates with the ultrafiltration (UF) membrane 14, which is supplied to the use point 15, and unused ultrapure water is returned to the front stage of the sub-system.

In the primary pure-water production apparatus 3 of the ultrapure-water production apparatus 1 as described above, the reverse osmosis membrane device 5, the ultraviolet oxidation device 7, and the electrical de-ionization device 9 are sequentially arranged, but when the treated water from the ultraviolet oxidation device 7 is channeled to the electrical de-ionization device 9, the hydrogen peroxide generated in the ultraviolet oxidation device may deteriorate the electrodes of the electrical de-ionization device 9 and the ion exchangers in the concentration chamber or the electrode chamber.

As a countermeasure, Patent Literature 1 proposes a method for operating a pure-water production system in which treated water from the reverse osmosis membrane device is channeled to the concentration chamber and the electrode chamber of the electrical de-ionization device by bypassing the ultraviolet oxidation device.

### CITATION LIST

### Patent Literature

[Patent Literature 1] International Publication No. 2020/045061

### SUMMARY OF INVENTION

### Technical Problem

However, the method for operating the pure-water production system described in Patent Literature 1 requires a bypass line for channeling the treated water from the reverse osmosis membrane device to the electrical de-ionization device, and for a large-scale pure-water production system, there is a problem that the cost of the apparatus increases due to the increase in long-distance piping.

The present invention has been made in view of the above problem, and an object of the present invention is to propose a method for operating a pure-water production system, which is capable of suppressing deterioration of the electrodes of the electrical de-ionization device and the ion exchangers in the concentration chamber and the electrode chamber by a simple configuration.

### Solution to Problem

In view of the above object, the present invention provides a method for operating a pure-water production system which includes an ultraviolet oxidation device and an electrical de-ionization device and channels water to these devices in this order from an upstream side. The method includes: setting hydrogen peroxide concentrations of concentrated water in a concentration chamber and electrode water in an electrode chamber of the electrical de-ionization device less than a hydrogen peroxide concentration of treated water that permeates through a desalination chamber of the electrical de-ionization device (invention 1). Particularly, in the above invention (invention 1), it is preferable that the hydrogen peroxide concentrations of the concentrated water in the concentration chamber and the electrode water in the electrode chamber of the electrical de-ionization device is set to ⅓ or less of the hydrogen peroxide concentration of the treated water that permeates through the desalination chamber of the electrical de-ionization device (invention 2).

According to such inventions (inventions 1 and 2), the treated water that has been treated by the ultraviolet oxidation device has an increased amount of hydrogen peroxide, and when this treated water is distributed to the concentration chamber/electrode chamber of the electrical de-ionization device, deterioration of the electrodes of the electrical de-ionization device and the ion exchangers in the concentration chamber and the electrode chamber is accelerated. Therefore, the operating conditions of the electrical de-ionization device are adjusted or set to lower the hydrogen peroxide concentration of the water supplied to the concentration chamber/electrode chamber, particularly to ⅓ or less of the hydrogen peroxide concentration of the treated water that permeates through the desalination chamber, thereby suppressing deterioration of the electrodes of the electrical de-ionization device and the ion exchangers in the concentration chamber and the electrode chamber, and extending the service life of the electrical de-ionization device.

In the above inventions (inventions 1 and 2), it is preferable that treated water treated by the ultraviolet oxidation device is supplied to the desalination chamber as treated water of the electrical de-ionization device, and part of permeated water in the desalination chamber of the electrical de-ionization device is channeled to the concentration chamber and the electrode chamber of the electrical de-ionization device as the concentrated water and the electrode water (invention 3). Particularly, in the above invention (invention 3), it is preferable that a water channeling direction of the desalination chamber and a water channeling direction of the concentration chamber of the electrical de-ionization device are of a countercurrent type (invention 4).

According to such inventions (inventions 3 and 4), when the treated water from the ultraviolet oxidation device permeates through the desalination chamber of the electrical de-ionization device, hydrogen peroxide is reduced. Thus, channeling part of this permeated water to the concentration chamber/electrode chamber of the electrical de-ionization device allows the water having a lower hydrogen peroxide concentration than the treated water that permeates through the desalination chamber to be used as the permeated water of the concentration chamber/electrode chamber. Particularly, setting the water channeling direction of the desalination chamber and the water channeling direction of the concentration chamber of the electrical de-ionization device to a countercurrent type achieves this with a simple structure.

In the above inventions (inventions 1 to 4), it is preferable that the pure-water production system is a primary pure-water apparatus of an ultrapure-water production apparatus that includes a primary pure-water apparatus and a secondary pure-water apparatus (invention 5).

According to such an invention (invention 5), since the service life of the electrical de-ionization device may be extended as described above, by controlling the operation of the pure-water production system that constitutes the primary pure-water apparatus of the ultrapure-water production apparatus as described above, the service life of the ultrapure-water production apparatus may be extended to stably supply the ultrapure water produced by the ultrapure-water production apparatus for a long period of time.

### Effects of Invention

The method for operating the pure-water production system according to the present invention sets the hydrogen peroxide concentration of the water supplied to the concentration chamber/electrode chamber low, particularly to ⅓ or less of the hydrogen peroxide concentration of the treated water that permeates through the desalination chamber, thereby suppressing deterioration of the electrodes of the electrical de-ionization device and the ion exchangers in the concentration chamber and the electrode chamber, and extending the service life of the electrical de-ionization device. As a result, the service life of the electrical de-ionization device may be extended with the pure-water production system that has a simple configuration.

### BRIEF DESCRIPTION OF DRAWINGS

FIG. 1 is a flow diagram showing an ultrapure-water production apparatus including a primary pure-water apparatus to which a method for operating a pure-water production system according to an embodiment of the present invention may be applied.

FIG. 2 is a schematic diagram showing an example of the structure of an electrical de-ionization device in the method for operating the pure-water production system according to the embodiment.

FIG. 3 is a schematic diagram showing the structure of an electrical de-ionization device in the method for operating the pure-water production system of Example 1.

FIG. 4 is a schematic diagram showing the structure of an electrical de-ionization device in the method for operating the pure-water production system of Comparative Example 1.

### DESCRIPTION OF EMBODIMENTS

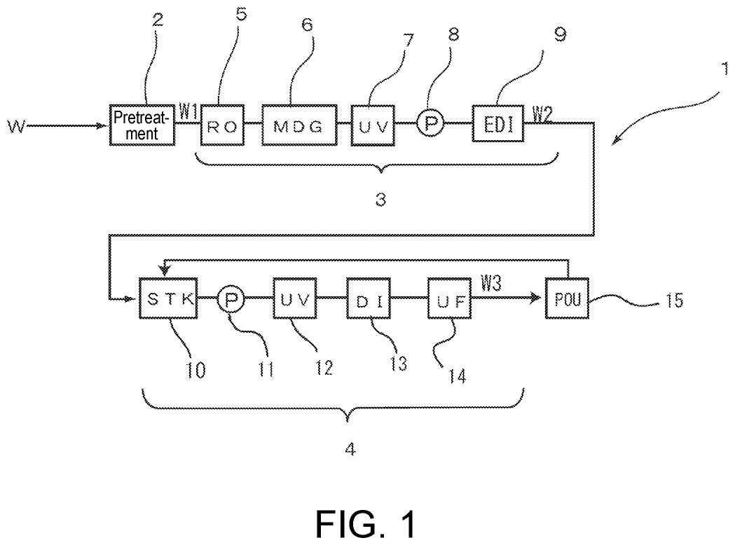

Hereinafter, a method for operating a pure-water production system according to an embodiment of the present invention will be described with reference to the accompanying drawings. FIG. 1 is a flow diagram showing an ultrapure-water production apparatus to which the method for operating the pure-water production system of this embodiment may be applied. Since the basic configuration of the pure-water production system is the same as the conventional example described above, detailed description thereof will be omitted.

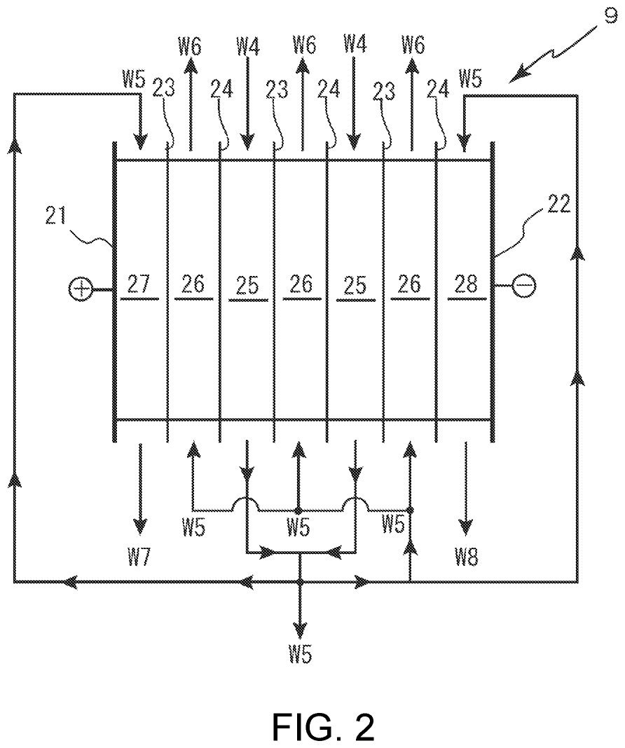

In the primary pure-water production apparatus 3 serving as the pure-water production system of this ultrapure-water production apparatus 1, treated water from the ultraviolet oxidation device 7 is channeled to the electrical de-ionization device 9. It is preferable that this electrical de-ionization device 9 has a configuration as shown in FIG. 2 in this embodiment.

### [Electrical De-Ionization Device]

In FIG. 2, the electrical de-ionization device 9 is a device in which a plurality of anion exchange membranes 23 and cation exchange membranes 24 are arranged alternately between the electrodes (positive electrode 21, negative electrode 22) to form desalination chambers 25 and concentration chambers 26 alternately, and a positive-electrode chamber 27 and a negative-electrode chamber 28 are formed on both sides. The desalination chamber 25 is filled with ion exchangers (anion exchanger and cation exchanger) made of ion exchange resin, ion exchange fiber, or graft exchanger in a mixed or multilayered form. Further, the concentration chamber 26, the positive-electrode chamber 27, and the negative-electrode chamber 28 are filled with ion exchangers in a similar manner.

In this embodiment, a concentration chamber channeling means (not shown) is provided in this electrical de-ionization device 7 to channel the treated water W4 that has been treated in the ultraviolet oxidation device 7 to the desalination chamber 25 to take out desalinated water W5 and fractionate and channel the desalinated water W5 to the concentration chamber 26, for the desalinated water W5 from the desalination chamber 25 to be introduced into the concentration chamber 26 from the side of the desalination chamber 25 near the outlet of the desalinated water W5 and flow out from the side of the desalination chamber 25 near the inlet of the treated raw water (treated water W4), that is, introducing the desalinated water W5 into the concentration chamber 26 from a direction opposite to the flow direction of the treated water W4 in the desalination chamber 25 to discharge concentrated water W6. On the other hand, the desalinated water W5 is also fractionated into the positive-electrode chamber 27 and the negative-electrode chamber 28 and distributed as electrode water, and is discharged as positive-electrode discharge water W7 and negative-electrode discharge water W8, respectively.

### [Method for Operating the Pure-Water Production System]

The method for operating the primary pure-water apparatus 3 having the above-described configuration will be described. First, pretreated water W1 obtained by pretreating raw water W with a pretreatment means 2 is supplied to the primary pure-water apparatus 3, and in addition to salts, ionic and colloidal TOC is removed by the reverse osmosis membrane (RO) device 5. Then, dissolved gas is removed by the de-aeration membrane device 6, and the remaining organic matter is decomposed in the ultraviolet oxidation device 7. The treated water W4 that has been treated by the ultraviolet oxidation device 7 is channeled to the electrical de-ionization device 9 to remove ionic impurities resulting from the organic matter decomposed through UV oxidation, thereby producing primary pure water W2.

At this time, the hydrogen peroxide concentration of the water supplied to the concentration chamber 26 and the electrode chambers (positive-electrode chamber 27, negative-electrode chamber 28) of the electrical de-ionization device 9 is set to be less than the hydrogen peroxide concentration of the treated water W4 supplied to the desalination chamber 25. The treated water W4 that has been treated by the ultraviolet oxidation device 7 has an increased amount of hydrogen peroxide, and when this treated water W4 is distributed to the concentration chamber 26 and the electrode chambers (positive-electrode chamber 27, negative-electrode chamber 28) of the electrical de-ionization device 9, deterioration of the electrodes 21 and 22 of the electrical de-ionization device 9 and the ion exchangers in the concentration chamber 26, the positive-electrode chamber 27, or the negative-electrode chamber 28 is accelerated. Therefore, by lowering the hydrogen peroxide concentration of the water supplied to the concentration chamber 26, the positive-electrode chamber 27, and the negative-electrode chamber 28, deterioration of the electrodes 21 and 22 of the electrical de-ionization device 9 and the ion exchangers in the concentration chamber 26, the positive-electrode chamber 27, or the negative-electrode chamber 28 may be suppressed to prevent an increase in the operating voltage of the electrical de-ionization device 9 and extend the service life. Particularly, by setting the hydrogen peroxide concentration to ⅓ or less of the hydrogen peroxide concentration of the treated water that permeates through the desalination chamber, the above effects may be suitably exhibited.

In this embodiment, the desalinated water W5 is fractionated and supplied to the concentration chamber 26 and the electrode chambers (positive-electrode chamber 27, negative-electrode chamber 28) of the electrical de-ionization device 9. Generally, the hydrogen peroxide concentration of the desalinated water W5 in the electrical de-ionization device 9 is lower than the hydrogen peroxide concentration of the treated water W4 that has been treated by the ultraviolet oxidation device 7, so this may be achieved with a simple structure. In addition, the hydrogen peroxide concentrations of the treated water W4 that has been treated by the ultraviolet oxidation device 7 and the desalinated water W5 that has passed through the desalination chamber 25 may be measured to confirm in advance that the hydrogen peroxide concentration of the desalinated water W5 is lower than the hydrogen peroxide concentration of the treated water W4, preferably ⅓ or less. Alternatively, the hydrogen peroxide concentrations of the treated water W4 that has been treated by the ultraviolet oxidation device 7 and the desalinated water W5 that has passed through the desalination chamber 25 may be measured continuously or intermittently by a hydrogen peroxide monitor, so as to control the voltage applied to the electrical de-ionization device 9 to set the hydrogen peroxide concentration of the desalinated water W5 to ⅓ or less of the hydrogen peroxide concentration of the treated water W4.

Particularly, in this embodiment, as the electrical de-ionization device 9, part of the desalinated water W5 that has passed through the desalination chamber 25 is channeled to the concentration chamber 26 as concentrated water in a countercurrent single pass manner in the direction opposite to the water channeling direction of the desalination chamber 25, and the concentrated water W6 is discharged from the concentration chamber 26 to the outside of the system, so the ion concentration of the concentrated water in the concentration chamber 26 decreases toward the outlet side of the desalination chamber 25, and the influence of concentration diffusion on the desalination chamber 25 is reduced. Therefore, the removal rate of weak ions such as boron is improved. Moreover, since the desalinated water W5 may have a lower hydrogen peroxide concentration than the treated water W4 that has been treated by the ultraviolet oxidation device 7, particularly ⅓ or less, employing such a configuration allows the concentrated water having a low hydrogen peroxide concentration to be easily supplied to the concentration chamber 26.

Once the primary pure water W2 is produced in this manner, the primary pure water W2 is stored in the sub-tank 10, and this primary pure water W2 is supplied by the supply pump 11 and treated. In the sub-system 4, treatment is performed using the ultraviolet oxidation device 12, the non-regenerative mixed bed ion exchange device 13, and the ultrafiltration membrane 14. In the ultraviolet oxidation device 12, TOC is decomposed into organic acids and further into CO₂ level by ultraviolet light with a wavelength of 185 nm emitted from a UV lamp. The decomposed organic acids and CO₂ are removed in the non-regenerative mixed bed ion exchange device 13 at the latter stage. In the ultrafiltration membrane 14, microparticles are removed, and particles discharged from the non-regenerative mixed bed ion exchange device 13 are also removed, thereby producing secondary pure water (ultrapure water) W3. After this ultrapure water W3 is supplied to the use point 15, the unused part is returned to the sub-tank 10, which enables the ultrapure-water production apparatus 1 to be operated.

Although the present invention has been described above based on the foregoing embodiment, the present invention is not limited to the embodiment described above, and various modifications can be made. For example, as long as the ultrapure-water production apparatus 1 applicable in the present invention has a configuration in which the primary pure-water apparatus 3 treats the treated water from the ultraviolet oxidation device 7 with the electrical de-ionization device 9, it is applicable to various configurations. In addition, the electrical de-ionization device 9 may be of a type in which the desalinated water and the concentrated water are in the same direction. Furthermore, although in the embodiment, the desalinated water W5 is supplied to the concentration chamber 26 of the electrical de-ionization device 9 as concentrated water, the water having a lower hydrogen peroxide concentration than the treated water W4 may be separately adjusted and supplied.

### EXAMPLE

### Example 1

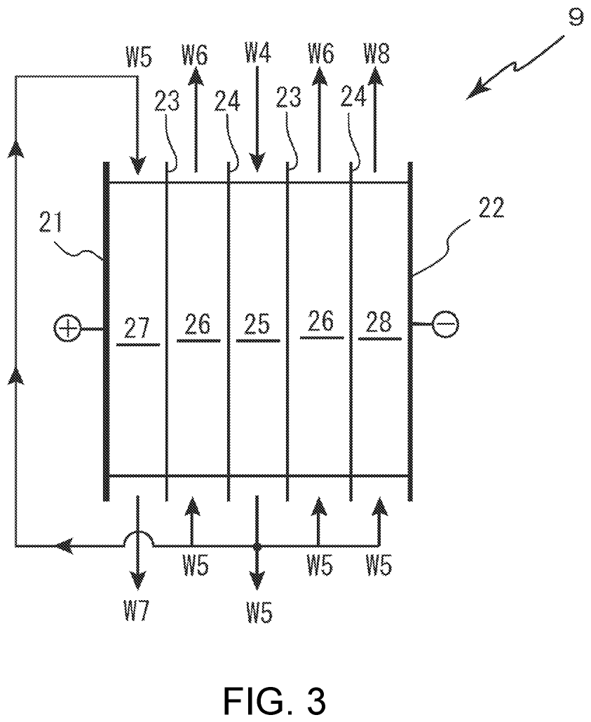

Water obtained by adding hydrogen peroxide to pure water (hydrogen peroxide concentration: 400 μg/L) was prepared as simulated water of the treated water from the ultraviolet oxidation device 7. This prepared water was channeled through the electrical de-ionization device 9 having the structure shown in FIG. 3 and Table 1 as the treated water W4 under the water channeling conditions shown in Table 2. Table 3 shows the results of measurement of the hydrogen peroxide concentrations of the treated water W4 at the inlet and the desalinated water W5 at the outlet of the desalination chamber 25 using a dissolved hydrogen peroxide meter (hydrogen peroxide monitor manufactured by KURITA WATER INDUSTRIES LTD.).

Changes in voltage were then measured as an indicator to confirm deterioration due to hydrogen peroxide. Voltage is one of the factors that determine device life, and in order to use the device for a long period of time, it is necessary to suppress an increase in voltage. Thus, the rising speed of the voltage after continuing the channeling of this treated water W4 for one week was measured. The permissible voltage rise (voltage change until the end of life) for the electrical de-ionization device used in this test was 5V from the voltage at the beginning of water channeling, and the device life under each condition was calculated based on this value. In addition, in this test, 400 μg/L of hydrogen peroxide was added, but the actual hydrogen peroxide concentration of the treated water from the ultraviolet oxidation device 7 is about 100 μg/L, so the predicted device life when channeling the treated water from the ultraviolet oxidation device was calculated by converting the concentration. Table 4 shows the calculation results of the rising speed of the voltage, the device life, and the device life assuming the treated water of the ultraviolet oxidation device (UV oxidation device).

### Comparative Example 1

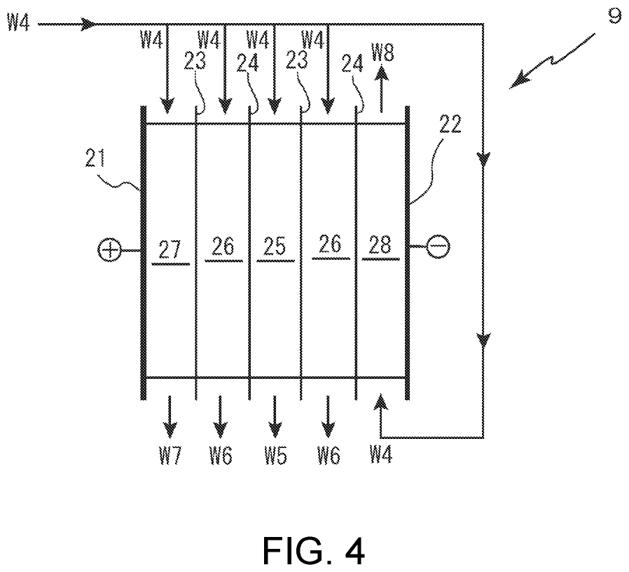

In Example 1, the same treated water W4 as in Example 1 was channeled through the electrical de-ionization device 9 having the structure shown in FIG. 4 and Table 1 under the water channeling conditions shown in Table 2. Table 3 also shows the results of measurement of the hydrogen peroxide concentrations of the treated water W4 at the inlet and the desalinated water W5 at the outlet of the desalination chamber 25 using a dissolved hydrogen peroxide meter. In addition, the rising speed of the voltage, the device life, and the device life assuming the treated water of the ultraviolet oxidation device were calculated in the same manner as in Example 1. The results are also shown in Table 4.

TABLE 1
Configuration of electrical de-ionization device

| Component | Number of cells | Filler |
|---|---|---|
| Desalination chamber | 1 | Ion exchange resin |
| Concentration chamber | 2 | (anion exchange resin:cation |
| | | exchange resin = 5:5) |
| Electrode chamber | 1 | Cation exchange resin |
| (positive electrode) | | |
| Electrode chamber | 1 | Expanded metal |
| (negative electrode) | | |

TABLE 2
Water channeling condition

| | |
|---|---|
| Desalination chamber flow rate | 400 mL/min |
| Concentration chamber flow rate | 100 mL/min |
| Electrode chamber flow rate | 50 mL/min |
| Recovery rate | 0.8 |
| Current value | 2A |

TABLE 3

| | Hydrogen peroxide concentration [μg/L] | |
|---|---|---|
| | Example 1 | Comparative Example 1 |
| Desalination chamber | 320 | 320 |
| water supply | | |
| Concentration | 78 | 320 |
| chamber/electrode | | |
| chamber water supply | | |

TABLE 4

| | Rising speed | Device | Device life assuming treated |
|---|---|---|---|
| | of voltage | life | water of UV oxidation device |
| Example No. | [V/day] | [day] | [day] |
| Example 1 | 0.0167 | 299.4 | 1197.6 |
| Comparative | 0.0405 | 123.5 | 493.8 |
| Example 1 | | | |

As is clear from Table 4, there was a difference of 700 days or more between Example 1 and Comparative Example 1 in terms of device life assuming that the treated water from the ultraviolet oxidation device was actually supplied to the desalination chamber. As shown in Table 3, it can be assumed that this is because, in Example 1, the hydrogen peroxide concentrations of the concentrated water supplied to the concentration chamber and the electrode water supplied to the electrode chamber are lower than the hydrogen peroxide concentration of the untreated water supplied to the desalination chamber, particularly ⅓ or less, even ¼ or less, to reach 100 μg/L.

### REFERENCE SIGNS LIST

1 Ultrapure-water production apparatus
2 Pretreatment apparatus
3 Primary pure-water production apparatus
4 Sub-system
5 Reverse osmosis membrane device
6 De-aeration membrane device
7 Ultraviolet oxidation device
8 Water-supply pump
9 Electrical de-ionization device
21 Positive electrode (electrode)
22 Negative electrode (electrode)
23 Anion exchange membrane
24 Cation exchange membrane
25 Desalination chamber
26 Concentration chamber
27 Positive-electrode chamber (electrode chamber)
28 Negative-electrode chamber (electrode chamber)
W Raw water
W1 Pretreated water
W2 Primary pure water
W3 Ultrapure water
W4 Treated water
W5 Desalinated water (concentrated water, electrode water)
W6 Concentrated water
W7 Positive-electrode discharge water
W8 Negative-electrode discharge water

1. A method for operating a pure-water production system, which comprises an ultraviolet oxidation device and an electrical de-ionization device and channels water to these devices in this order from an upstream side, the method comprising: setting hydrogen peroxide concentrations of concentrated water in a concentration chamber and electrode water in an electrode chamber of the electrical de-ionization device less than a hydrogen peroxide concentration of treated water that permeates through a desalination chamber of the electrical de-ionization device.

2. The method for operating the pure-water production system according to claim 1, wherein the hydrogen peroxide concentrations of the concentrated water in the concentration chamber and the electrode water in the electrode chamber of the electrical de-ionization device is set to ⅓ or less of the hydrogen peroxide concentration of the treated water that permeates through the desalination chamber of the electrical de-ionization device.

3. The method for operating the pure-water production system according to claim 1, wherein treated water treated by the ultraviolet oxidation device is supplied to the desalination chamber as treated water of the electrical de-ionization device, and part of permeated water in the desalination chamber of the electrical de-ionization device is channeled to the concentration chamber and the electrode chamber of the electrical de-ionization device as the concentrated water and the electrode water.

4. The method for operating the pure-water production system according to claim 3, wherein a water channeling direction of the desalination chamber and a water channeling direction of the concentration chamber of the electrical de-ionization device are of a countercurrent type.

5. The method for operating the pure-water production system according to claim 1, wherein the pure-water production system is a primary pure-water production apparatus of an ultrapure-water production apparatus that comprises a primary pure-water production apparatus and a secondary pure-water production apparatus.

6. The method for operating the pure-water production system according to claim 2, wherein treated water treated by the ultraviolet oxidation device is supplied to the desalination chamber as treated water of the electrical de-ionization device, and part of permeated water in the desalination chamber of the electrical de-ionization device is channeled to the concentration chamber and the electrode chamber of the electrical de-ionization device as the concentrated water and the electrode water.

7. The method for operating the pure-water production system according to claim 6, wherein a water channeling direction of the desalination chamber and a water channeling direction of the concentration chamber of the electrical de-ionization device are of a countercurrent type.

8. The method for operating the pure-water production system according to claim 2, wherein the pure-water production system is a primary pure-water production apparatus of an ultrapure-water production apparatus that comprises a primary pure-water production apparatus and a secondary pure-water production apparatus.

9. The method for operating the pure-water production system according to claim 3, wherein the pure-water production system is a primary pure-water production apparatus of an ultrapure-water production apparatus that comprises a primary pure-water production apparatus and a secondary pure-water production apparatus.

10. The method for operating the pure-water production system according to claim 4, wherein the pure-water production system is a primary pure-water production apparatus of an ultrapure-water production apparatus that comprises a primary pure-water production apparatus and a secondary pure-water production apparatus.

11. The method for operating the pure-water production system according to claim 6, wherein the pure-water production system is a primary pure-water production apparatus of an ultrapure-water production apparatus that comprises a primary pure-water production apparatus and a secondary pure-water production apparatus.

12. The method for operating the pure-water production system according to claim 7, wherein the pure-water production system is a primary pure-water production apparatus of an ultrapure-water production apparatus that comprises a primary pure-water production apparatus and a secondary pure-water production apparatus.
